(19) United States
(12) Patent Application Publication
(10) Pub. No.: US 2005/0254249 A1
(43) Pub. Date: Nov. 17, 2005

(54) Dock lighting system

(76) Inventor: Edward S. Robbins III, Muscle Shoals, AL (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 10/843,099

(22) Filed: May 11, 2004

(51) Int. Cl. B60Q 1/26

(52) U.S. Cl. 362/485; 362/501; 362/543

(57) ABSTRACT

A dock lighting system fixed adjacent to a doorway to provide navigational aid for truck operators has a substantially linear light source of low luminosity covered by a strip mounted over the linear light source of a brightly colored, translucent to transparent flexible material.

### BACKGROUND OF THE INVENTION

The present invention is directed to lighting systems for use adjacent to openings such as doorways, particularly doorways defining a docking area for tractor trailers and other trucks.

Dock door openings are often situated at spaced intervals along a docking area. The docking area is typically approached by trucks backing into the docking area, hopefully in alignment with a selected door opening. While this can be reasonably easily accomplished by a skilled truck operator in daylight, the same task is rendered much more difficult at night, particularly during inclement weather conditions.

To aid in correctly locating a truck or trailer relative to a dock opening, some docks have included dock seals having reflective portions. The reflective portions are intended to be sufficiently illuminated by backup lights or brake lights on the truck or trailer so that the sides of a given dock opening are outlined. Examples of such dock seals incorporating reflective materials are found in U.S. Pat. Nos. 3,994,103, 4,038,792 and 4,679,364. While such reflective materials may operate satisfactorily in certain circumstances, experience has shown that over time as the reflective materials become scuffed and scratched the reflective materials often fail to provide adequate lighting to guide the truck operator, particularly in bad weather conditions.

There is therefore a need for an enhanced outline for door openings in dock areas to provide a navigational aid for truck operators. There is also a need to provide such enhanced outlining while consuming as little power as possible. There is also a need to provide such enhanced outlining while avoiding any un-necessary light pollution of adjacent areas.

### SUMMARY OF THE INVENTION

A dock lighting system in accordance with the present invention includes a substantially linear light source fixed to the wall immediately adjacent to a door opening to provide a navigational aid for truck operators. The substantially linear light source can be continuous or take form of a string or row of individual lighting units. A covering strip is mounted over the linear light source, the strip comprising a flexible translucent to transparent material, preferably brightly colored so as to demand enhanced attention. A particularly advantageous color is a super bright fluorescent orange pigment that can be compounded into flexible PVC stripping. The stripping can be 4 to 20 inches wide, preferably about 8-16 inches wide. The flexible stripping can be attached over the linear light source with the aid of threaded fasteners such as self-taping screws and grommets. The flexible stripping can also be attached over the linear light source with the aid of a plurality of studs or pegs fixed to the wall adjacent to the doorway. Preferably the pegs have enlarged end caps while the plastic stripping can include a series of openings positioned for alignment with and sized to accept the fixed pegs. The stripping can be secured to the wall by merely pushing the stripping over the series of pegs.

This structure has the advantage of providing a low-power, high visibility outline for the dock opening or doorway, while contributing very little to the background light pollution. This structure also has the advantage of easy assembly and secure retention of the plastic stripping over the linear light source, yet permits easy temporary removal of the stripping, if necessary, for servicing the linear light source.

Additional features and advantages of the present invention will be appreciated from the review of the following description of preferred embodiments that should be considered in conjunction with the accompanying drawings.

### BRIEF DESCRIPTION OF THE DRAWINGS

FIG. 1 is a perspective view of a dock opening incorporating lighting systems of the present invention.

FIG. 2 is a sectional view taken along lines 2-2 showing a preferred attachment of flexible stripping over a linear light source.

FIG. 3 is a sectional view taken along lines 3-3 showing a preferred attachment of flexible stripping over a linear light source.

FIG. 4 is a sectional detail of one anchoring peg that can be used to secure the flexible stripping to the adjacent wall.

FIG. 5 is a sectional detail of another anchoring peg that can be used to secure the flexible stripping to the adjacent wall.

FIG. 6 is a perspective view of another preferred attachment of flexible stripping of a linear light source.

FIG. 7 is a sectional view of a flexible stripping that includes discrete light-supporting ribs.

### DESCRIPTION OF PREFERRED EMBODIMENTS

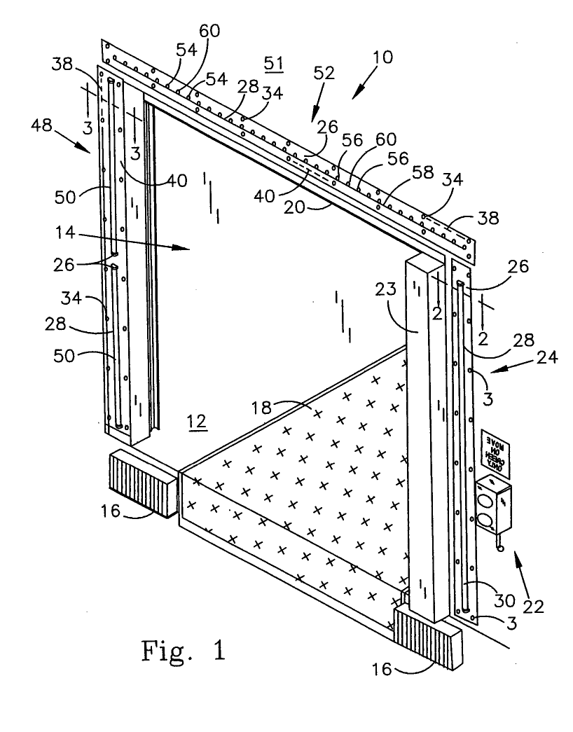

A docking area 10 for tractor trailers and other truck is shown in FIG. 1 to include a loading dock 12 and a door opening 14 as viewed from the outside. The loading dock 12 has conventional bumpers 16 and a conventional dock leveling platform 18. The dock door 20 can be the usual overhead type door which is shown in the open position in FIG. 1. A warning light 22 is provided at one side of the door opening 14 of the type produced by DL Manufacturing of East Syracuse, N.Y. A dock seal 23 is shown on the right side of the door opening 14, but those skilled in the art will recognize that dock seals usually surround the entire door opening 14, and the remainder of the dock seal 23 is omitted for ease of illustration.

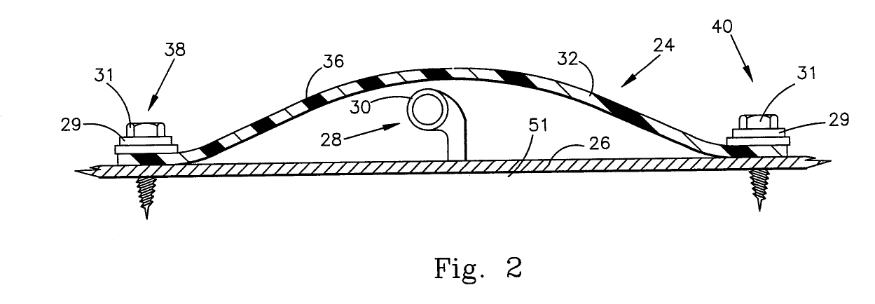

A first dock lighting system 24 of the present invention to provide navigational aid for truck operators is shown in FIG. 1 on the right side of the door opening 14 outside the dock seal 23 and adjacent to the warning light 22. The lighting system 24 includes a support 26 fixed adjacent to the door opening 14. A substantially linear light source 28 in the form of a neon tube 30 is fixed to the support 26. A covering strip 32 is mounted over the linear light source and fixed to the support 26 by a plurality of screw-threaded fasteners 31 as shown in FIG. 2. The fasteners 31 can be self-taping screws including flanged heads 29 and can be employed with grommets 27 to secure the covering strip 32 to the underlying support 26 or to the wall 51. The covering strip 32 consists of a brightly colored, translucent to transparent flexible plastic material sheet 36 that is penetrable by the fasteners 31. The covering strip 32 is sufficiently pliable to permit the covering strip 32 to flex as it conforms in a middle portion to the outwardly projecting sight source 30 and along the outer edges to the underlying support 26 or wall 51.

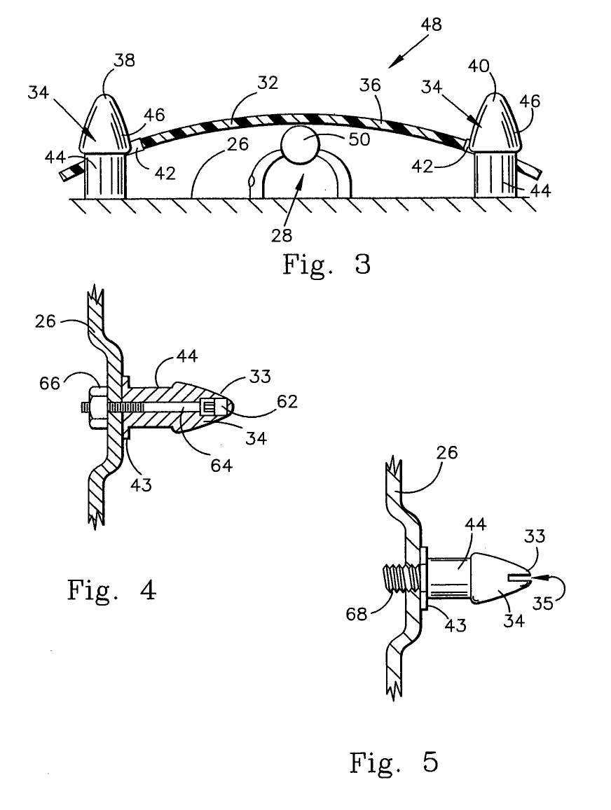

A second dock lighting system 48 of the present invention to provide navigational aid for truck operators is shown on the left side of the door opening 14. The lighting system 24 includes a support 26 fixed adjacent to the door opening 14. A substantially linear light source 28 in the form of a fluorescent tube 50 is fixed to the support 26. A covering strip 32 is mounted over the linear light source and fixed to the support 26 by a plurality of studs 34 as shown in FIG. 3. The covering strip 32 again consists of a brightly colored, translucent to transparent flexible plastic material sheet 36. The studs 34 are arranged in two linear arrays 38 and 40 that project outward from the support 26. The covering strip 32 includes a series of holes 42 sized to receive the outwardly projecting studs 34. Each of the studs 34 includes a stem portion 44 about the size of the holes 42 in the covering strip 32. Each of the studs 34 also includes an enlarged end cap 46 that is generally larger than the size of the holes 42 in the covering strip 32. The covering strip 32 is sufficiently pliable to permit the covering strip 32 to be pushed over the enlarged end caps 46 to secure the covering strip 32 to the support 26.

A third dock lighting system 52 of the present invention is shown above the door opening 14 in FIG. 1. The lighting system 52 includes a substantially linear light source 28 in the form of a series of individual point sources 54 formed by a series of bulbs 56 on an electrical wire string 58. The wire string can be fixed to an underlying support 26 with a series of clips 60 fixed to the support 26. Again, a plurality of screw-threaded fasteners 31 or studs 34 can be arranged in two linear arrays 38 and 40 and are adapted to connect to covering strip 32 as previously described in connection with the first and second lighting systems 24 and 48, respectively.

The outwardly projecting studs 34 of the second and third lighting systems can be secured to any underlying wall 51 or support 26 in a variety of ways. For example, the studs 34 can include an axial opening 62 as shown in FIG. 4 that is sized to receive a fastener 64 in the nature of a screw or bolt, which can engage a corresponding fastener 66 fixed to the support 26. Alternatively, the studs 34 can include an integral threaded portion 68 at the base of the stem portion 44 as shown in FIG. 5 that can be directly secured into the support 26 or a suitably prepared hole in the underlying wall 51. The nose 33 of the studs 34 can include one or more slots 35 or other openings to receive a suitable tool, such as a screw driver, to facilitate the engagement of the studs 34 with the underlying wall 51 or support 26. A base portion 43 at the base of the stem 44 can also be configured as a square, hex, or other shape that will facilitate engagement with a wrench to aid in the engagement of the studs 34 with the underlying wall 51 or support 26.

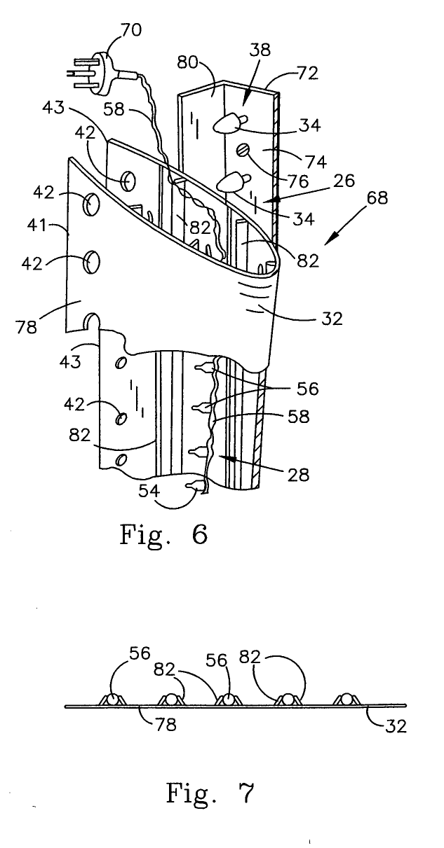

A fourth dock lighting system 68 of the present invention is shown in FIG. 6. The lighting system 68 includes a substantially linear light source 28 in the form of a series of individual point sources 54 formed by a series of bulbs 56 on an electrical wire string 58. The wire string 58 can include a conventional electrical plug 70 to connect the light source 28 to a suitable source of power, not shown. An underlying support 26 is provided in the form of an angle bracket 72 including a base portion 74 adapted to be secured to the wall 51 by fasteners 76. A single array 38 of studs 34 projects outward from the base portion 74 of the support 26 and is adapted to connect to covering strip 32. The covering strip 32 is in the form of a brightly colored, translucent to transparent flexible plastic material sheet 78 that includes two series of holes 42 on opposite edges 41 and 43 of the covering strip 32 as previously described in connection with the first lighting system 24. However, both series of holes 42 are intended to be coupled to the single array 38 of studs 34 projecting outward from the base portion 74 of the support 26. An outwardly projecting portion 80 of the angle bracket 72 protects the covering strip 32 from accidental dislodgement from the support 26. The plastic material sheet 78 can also include a series of internal diagonal ribs 82, as shown in cross-section in FIG. 7, that are arranged in pairs to hold the individual bulbs 56 at any selected lateral location within the strip. Once the individual bulbs 56 are installed, the frictional force provided by the converging diagonal ribs 82 secures the bulbs 56 at the selected locations.

The foregoing detailed description should be regarded as illustrative rather than limiting, and the following claims, including all equivalents, define the spirit and scope of this invention.

1. A dock lighting system to provide navigational aid for truck operators comprising: a support fixed adjacent to a doorway in a wall, a substantially linear light source positioned adjacent to the support, a covering strip mounted over the linear light source and fixed to the support, the covering strip comprising a brightly colored, translucent to transparent flexible material.

2. The dock light system of claim 1 wherein the substantially linear light source comprises a linear fluorescent light.

3. The dock light system of claim 1 wherein the substantially linear light source comprises a string of substantially equally spaced point sources.

4. The dock light system of claim 1 wherein the support comprises a linear array of projections projecting outward from the wall adjacent the doorway and the covering strip includes a series of holes sized to receive the linear array of projections.

5. The dock light system of claim 4 wherein the projections include enlarged end caps and the covering strip is sufficiently pliable to permit the covering strip the be pushed over the enlarged end caps to secure the covering strip to the wall.

6. The dock light system of claim 1 wherein the covering strip is brightly colored so as to demand enhanced attention.

7. The dock light system of claim 6 wherein the color is provided by a super bright fluorescent orange pigment that can be compounded into flexible PVC stripping.

8. The dock light system of claim 1 further comprising a plurality of fasteners for fastening the covering strip in position over the light source.
